(19) United States
(12) Patent Application Publication
(10) Pub. No.: US 2008/0257937 A1
(43) Pub. Date: Oct. 23, 2008

(54) Electronic Component Mounting System, Electronic Component Mounting Device, and Electronic Component Mounting Method

(75) Inventors: Masahiro Kihara, Fukuoka (JP); Masafumi Inoue, Saga (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Kadoma-shi, Osaka (JP)

(21) Appl. No.: 11/569,126

(22) PCT Filed: Jan. 17, 2006
(86) PCT No.: PCT/JP2006/300915

§ 371 Date: Nov. 15, 2006

(30) Foreign Application Priority Data
Jan. 18, 2005 (JP) 2005-009873

(51) Int. Cl. B23K 37/04

(52) U.S. Cl. 228/9

(57) ABSTRACT

To provide an electronic component mounting system, an electronic component placing device, and an electronic component mounting method, which can prevent waste due to the place of an electronic component onto a unit substrate having a print failure.

In the electronic component mounting method for mounting an electronic component on a multi-substrate in which a plurality of unit substrates are formed on the same substrate, the quality of a print state of a solder printed on electrodes formed on the plurality of unit substrates is determined by the test of the print state of the solder and a determination result is output to an electronic component placing device as solder test data in every unit substrate. In a component placing steps, a component placing mechanism is controlled based on the solder test data such that a component placing operation is performed only on the unit substrate in which the print state of the solder is determined to be good. Accordingly, it is possible to prevent waste due to the place of an electronic component onto a unit substrate having a print failure.

### TECHNICAL FIELD

The present invention relates to an electronic component mounting system, an electronic component mounting device, and an electronic component mounting method for mounting an electronic component on a substrate.

### BACKGROUND ART

An electronic component mounting system for mounting an electronic component on a substrate to manufacture a mounting substrate includes a plurality of electronic component mounting devices such as a solder print device, an electronic component placing device, and a reflow device, all of which are connected to one another. As a substrate which is an operation object of the electronic component mounting system, there is a multi-substrate in which a plurality of unit substrates are assembled on one substrate. This multi-substrate is treated as one substrate in a mounting process and is divided into the unit substrates to make individual products. In a method of managing the quality of the multi-substrate, a bad mark may be applied to the unit substrate to display the quality of each unit substrate (for example, see Japanese Patent Publication JP-A-2000-124692).

In an example disclosed in JP-A-2000-124692, the bad mark is previously applied to the unit substrate which is determined to be inferior in quality. By representing the bad mark on each unit substrate and recognizing the bad mark in a post-process, it is possible to prevent an electronic component from being unnecessarily mounted on a bad unit substrate.

However, the bad mark conventionally represents only a failure discovered by quality test in a process of manufacturing a substrate, and a detected bad item does not apply to a mounting process. To this end, even when a bad print state of a solder printed on each unit substrate by a solder print device is detected by solder print test, the electronic component placing device of the post-process places the electronic component on all the unit substrates, regardless of the quality of the print state of the solder.

Accordingly, in the unit substrate on which the component is placed in the bad print state of the solder, a probability of generating solderjoint failure after reflowing is high and thus a plurality of bad products may be generated. In addition, since the unit substrate having the solder joint failure is almost discarded, a component such as an expensive semiconductor chip is wastefully discarded.

### DISCLOSURE OF INVENTION

Accordingly, an object of the present invention is to provide an electronic component mounting system, an electronic component placing device, and an electronic component mounting method, which can prevent waste caused by the place of an electronic component onto a unit substrate having a print failure.

According to the present invention, there is provided an electronic component mounting system which includes a plurality of electronic component mounting devices connected to one another and mounts an electronic component on a multi-substrate in which a plurality of unit substrates are formed on the same substrate by solderjoint to manufacture a mounting substrate, including: a print device which prints a solder on electrodes of the plurality of unit substrates; a print test device which determines the quality of a print state of the solder and outputs a determination result as solder test data in every unit substrate; an electronic component placing device which has a component placing mechanism for picking up the electronic component from a component supply unit and placing the electronic component on the plurality of unit substrates on which the solder is printed; and a place control means which controls the component placing mechanism based on the solder test data to perform a component placing operation only on the unit substrate in which the print state of the solder is determined to be good.

According to the present invention, there is provided an electronic component placing device for placing an electronic component in a multi-substrate on which a plurality of unit substrates are formed on the same substrate, including: a print test unit which determines the quality of a print state of a solder printed on electrodes formed on the plurality of unit substrates and outputs a determination result as solder test data in every unit substrate; a component placing mechanism which picks up the electronic component from a component supply unit and places the electronic component on the plurality of unit substrates on which the solder is printed; and a place control means which controls the component placing mechanism based on the solder test data to perform a component placing operation only on the unit substrate in which the print state of the solder is determined to be good.

According to the present invention, there is provided an electronic component mounting method for mounting an electronic component on a multi-substrate in which a plurality of unit substrates are formed on the same substrate, including: a print test step for determining the quality of a print state of a solder printed on electrodes formed on the plurality of unit substrates and outputting a determination result as solder test data in every unit substrate; and a component placing steps for picking up the electronic component from a component supply unit by a component placing mechanism and placing the electronic component on the plurality of unit substrates on which the solder is printed, wherein, in the component placing step, the component placing mechanism is controlled based on the solder test data such that a component placing operation is performed only on the unit substrate in which the print state of the solder is determined to be good.

According to the present invention, since a determination result of a print state of a solder is output as solder test data in every unit substrate, and, in a component placing step, a component placing mechanism is controlled based on the solder test data such that a component placing operation is performed only on the unit substrate in which the print state of the solder is determined to be good, it is possible to prevent waste due to the place of the electronic component onto the unit substrate having a print failure.

### BRIEF DESCRIPTION OF DRAWINGS

FIG. 1 is a block diagram illustrating a configuration of an electronic component mounting system according to an embodiment of the present invention.

FIG. 2 is a block diagram illustrating a configuration of a print device according to an embodiment of the present invention.

FIG. 3 is a block diagram illustrating a configuration of a print test device according to an embodiment of the present invention.

FIG. 4 is a block diagram illustrating a configuration of an electronic component placing device according to an embodiment of the present invention.

FIG. 5 is a block diagram of a control unit of the electronic component mounting system according to an embodiment of the present invention.

FIGS. 6(a) and 6(b) are plan views of a substrate which is a component placing object, according to an embodiment of the present invention.

FIG. 7 is a flowchart illustrating operations of the electronic component mounting system according to an embodiment of the present invention.

FIGS. 8(a) to 8(d) are views explaining an electronic component mounting method according to an embodiment of the present invention.

FIG. 9 is a block diagram illustrating a configuration of a print device in the electronic component mounting system according to an embodiment of the present invention.

FIG. 10 is a block diagram illustrating a configuration of an electronic component placing device in the electronic component mounting system according to an embodiment of the present invention.

### BEST MODE FOR CARRYING OUT THE INVENTION

Next, embodiments of the present invention will be described with reference to the accompanying drawings.

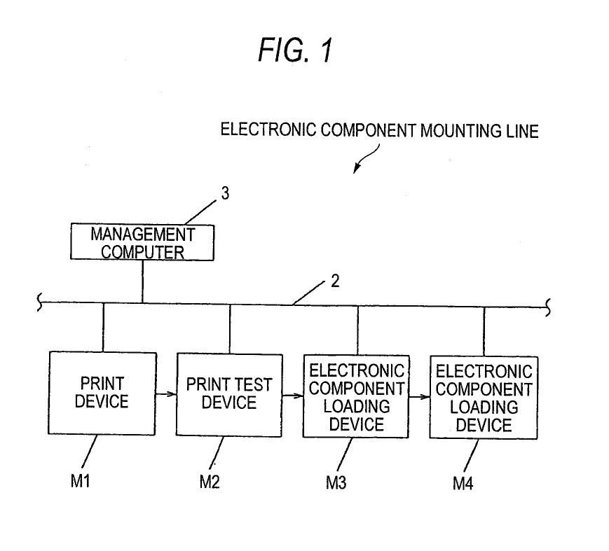

First, the electronic component mounting system will be described with reference to FIG. 1. In FIG. 1, in the electronic component mounting system, an electronic component mounting line 1 includes a print device M1, a print test device M2, and electronic component placing devices M3 and M4, all of which are electronic component mounting devices and connected to one another by a communication network 2, and controlled by a management computer 3. This electronic component mounting system has a function for mounting an electronic component on a substrate by solder joint to manufacture a mounting substrate by the plurality of electronic component mounting devices. In other words, the print device M1 screen-prints a soldering paste forjoining the electronic component on an electrode of the substrate. The print test device M2 tests a print state of the printed soldering paste. The electronic component placing devices M3 and M4 place the electronic component on the substrate on which the soldering paste is printed.

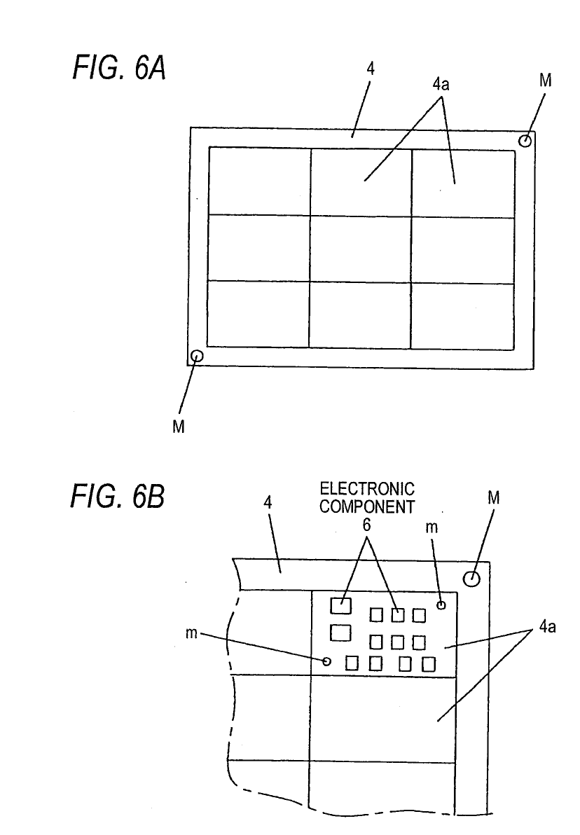

First, a substrate 4, which is a mounting object, will be described with reference to FIGS. 6(a) and 6(b). As illustrated in FIG. 6(a), the substrate 4 is a multi-substrate in which a plurality of unit substrates are provided on the same substrate, and the electronic component mounting system mounts electronic components on the unit substrates 4a to manufacture mounting substrates. When the substrate 4 moves in the electronic component mounting line, the plurality of unit substrates 4a are treated as one substrate and the position of the substrate 4 is recognized by recognizing a whole recognition mark M. In addition, after the mounting operation is finished, the substrate 4 is divided into the unit substrates 4a such that the respective unit substrates 4 become individual products.

As illustrated in FIG. 6(b), each unit substrate 4a is provided with a plurality of electrodes 6 for mounting the electronic components. A soldering paste is printed on the electrodes 6 by the print device M1, and the soldering paste printed on the electrodes 6 becomes a test object of the print test device M2. Furthermore, in the electronic component mounting devices M3 and M4, the electronic components are placed on the electrodes 6 of the plurality of unit substrates 4a. In this component mounting operation, the position of each unit substrate 4a is recognized by recognizing a recognition mark m provided on each unit substrate 4a.

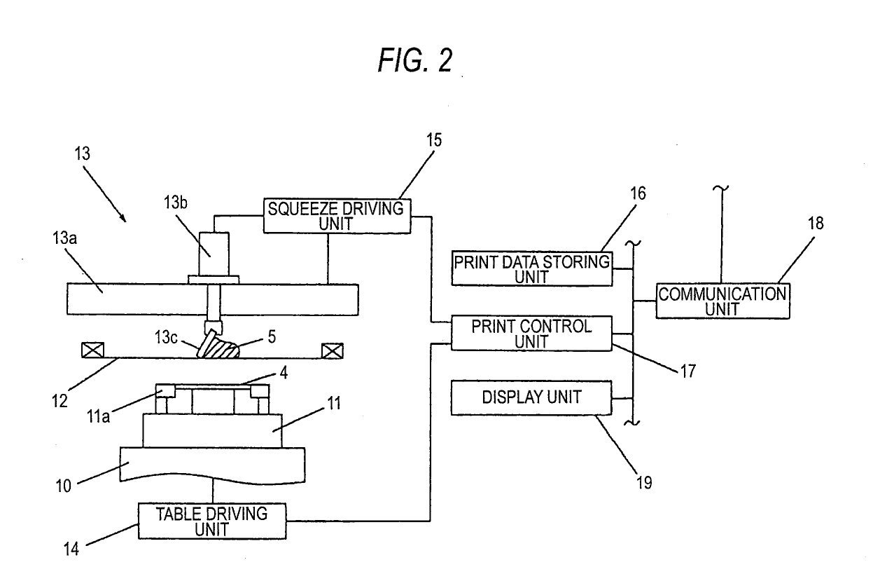

Next, the configurations of the devices will be described. First, the configuration of the print device M1 will be described with reference to FIG. 2. In FIG. 2, a substrate holding unit 11 is provided on a positioning table 10. The substrate holding unit 11 holds the substrate 4 by fitting the both sides of the substrate 4 into a damper 11a. A mask plate 12 is provided above the substrate holding unit 11 and a pattern hole (not illustrated) corresponding to a print portion of the substrate 4 is formed in the mask plate 12. By driving the positioning table 10 by a table driving unit 14, the substrate 4 relatively moves with respect to the mask plate 12 in a horizontal direction and a vertical direction.

A squeeze unit 13 is provided above the mask plate 12. The squeeze unit 13 includes an elevating/pressing mechanism 13b for elevating a squeeze 13c with respect to the mask plate 12 and pressing the squeeze 13c with respect to the mask plate 12 with a predetermined press force and a squeeze moving mechanism 13a for horizontally moving the squeeze 13c. The elevating/pressing mechanism 13b and the squeeze moving mechanism 13a are driven by a squeeze driving unit 15. By horizontally moving the squeeze 13c at a predetermined speed along the surface of the mask plate 12 to which a soldering paste 5 is fed, in a state of bringing the substrate 4 into contact with the lower surface of the mask plate 12, the soldering paste 5 is printed on the electrodes 6 formed on the plurality of unit substrates 4a through the pattern hole (not illustrated).

This print operation is performed by controlling the table driving unit 14 and the squeeze driving unit 15 by a print control unit 17. At the time of controlling, the operation of the squeeze 13c or the alignment between the substrate 4 and the mask plate 12 is controlled based on print data stored in a print data storing unit 16. A display unit 19 displays various indication data representing an operation state of the print device or abnormal annunciation representing an abnormal state of the print operation. A communication unit 18 transmits/receives data to/from the management computer 3 or the other devices configuring the electronic component mounting line 1 over the communication network 2.

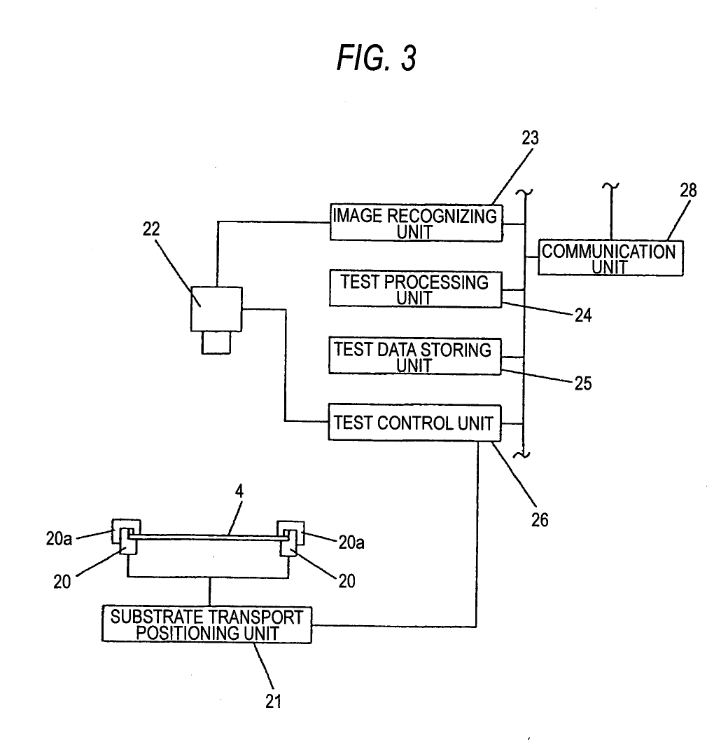

Next, the print test device M2 will be described with reference to FIG. 3. In FIG. 3, the substrate 4 of which the both ends are clamped by a clamp member 20a is held on a transport rail 20. By driving a substrate transport positioning unit 21, the transport rail 20 transports and positions the substrate 4 at a position for the below-described test and measurement. A camera 22 are provided above the substrate 4 held on the transport rail 20. An image recognizing unit 23 recognizes a result photographed by the camera 22 such that the print state of the soldering paste 5 is tested, that is, it is determined whether the soldering paste 5 is accurately printed on the electrodes 6 of the print objects by a predetermined amount of solder without misalignment.

Since the camera 22 can move in a horizontal plane by a moving unit, any position of the substrate 4 may be tested in every unit substrate 4a. The quality of the result recognized by the image recognizing unit 23 is determined by a test processing unit 24 and output as solder test data in every unit substrate 4a. The output data is transmitted to the management computer 3 or the other device over a communication unit 28 and the communication network 2. A test control unit 26 controls the substrate transport positioning unit 21 and the camera 22 to control the test operation.

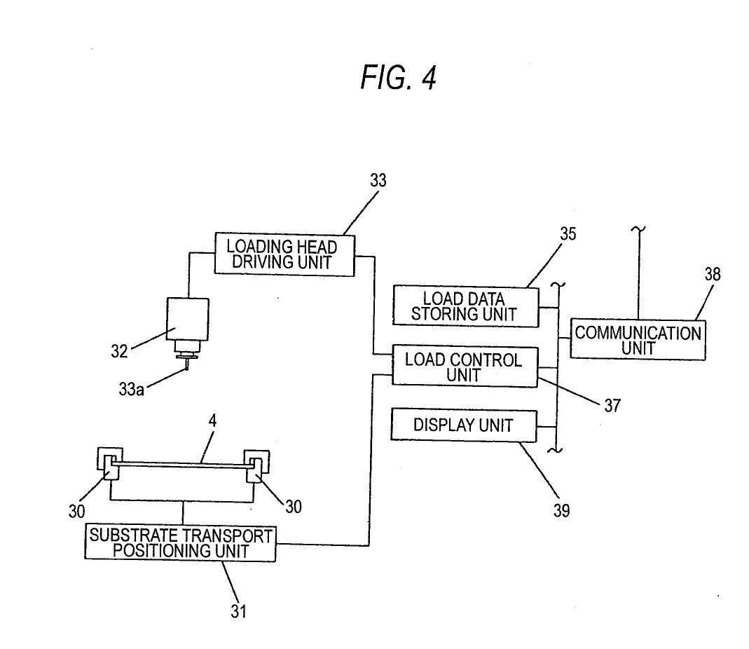

Next, the configurations of the electronic component placing devices M3 and M4 will be described with reference to FIG. 4. The electronic component placing devices M3 and M4 have the same structure and share an operation of mounting the components on the substrate 4. The substrate 4 of which the both ends are clamped by a clamp member 30a is held on a transport rail 30. By driving a substrate transport positioning unit 31, the transport rail 30 transports and positions the substrate 4 at a component placing position of the below-described placing head 32. The placing head 32, which moves by a head driving mechanism (not illustrated), is provided above the substrate 4 held on the transport rail 30.

The placing head 32 includes a nozzle 32a for attaching the electronic component, and picks up the electronic component from a component supply unit (not illustrated) by the nozzle 32a. Thereafter, the placing head 32 moves onto the substrate 4 and falls toward the substrate 4 such that the electronic component held by the nozzle 32a is placed on any one of the plurality of unit substrates 4a on which the soldering paste 5 is printed. The placing head 32 and the head driving mechanism are component placing mechanisms for picking up the electronic component from the component supply unit and placing the electronic component on any one of the plurality of unit substrates 4a on which the soldering paste is printed.

In the placing operation, a place control unit 37 controls a substrate transport positioning unit 31 and a placing head driving unit 33 based on place data stored in a place data storing unit 35, that is, a coordinate for mounting the electronic component on the substrate 4, thereby controlling the electronic component placing position of the substrate 4 by the placing head 32. A display unit 39 displays indication data representing various movement states of the electronic component placing device M3 or abnormal annunciation representing an abnormal state of the placing operation. A communication unit 38 transmits/receives data to/from the management computer 3 or the other devices configuring the electronic component mounting line 1 over the communication network 2.

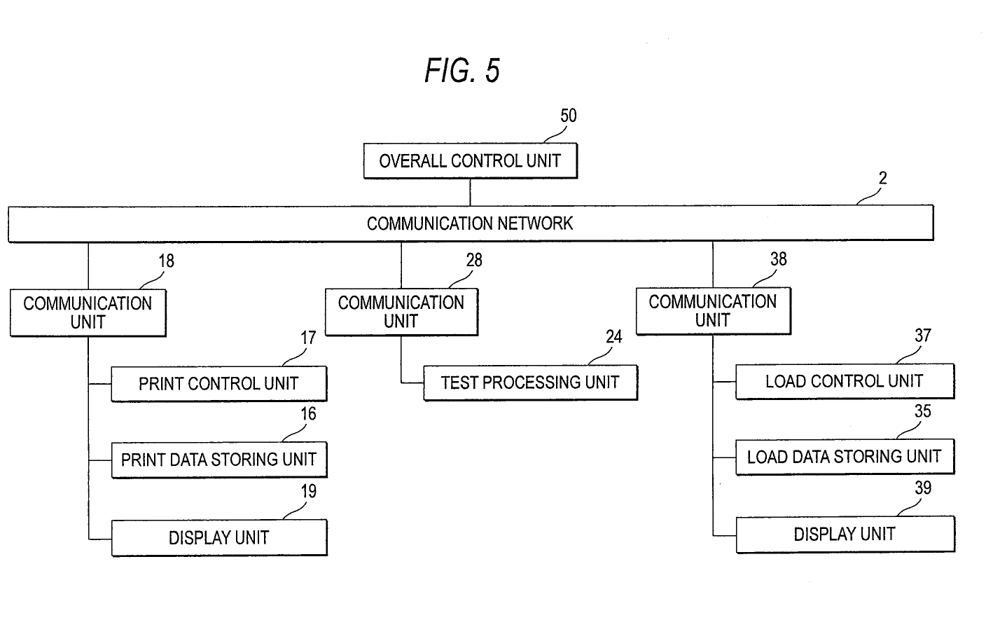

Next, the configuration of the control unit of the electronic component mounting system will be described with reference to FIG. 5. In FIG. 5, an overall control unit 50 performs a data transmitting/receiving function in a control range which is executed by the management computer 3, receives the data from the respective devices configuring the electronic component mounting line over the communication network 2, and outputs the data to the respective devices over the communication network 2 based on a predetermined process algorithm.

In other words, the test processing unit 24 included in the print test device M2 illustrated in FIG. 3 is connected to the communication network 2 through the communication unit 28. In addition, the respective units (see FIG. 2 and FIG. 4) included in the print device M1 and the electronic component placing devices M3 and M4 are connected to the communication network 2 through the communication devices 18 and 38, respectively. Accordingly, a feedback process for correcting and updating a control parameter of an upstream device or a feed-forward process for correcting and updating a control parameter of a downstream device based on the data extracted in the test process of the print test device M2 can be, if necessary, performed during operating the respective devices. In addition, in FIG. 5, the electronic component placing device M4 is not illustrated.

In the present embodiment, solder test data representing the test result of the print state of the solder performed by the print test device M2 is transmitted to the electronic component placing devices M3 and M4, the execution of the component placing operation of the electronic component placing devices M3 and M4 is controlled by the place control unit 37 based on the solder test data, and the component placing operation is performed only on the unit substrates 4a in which the print state of the solder is determined to be good. In other words, the place control unit 37 of the electronic component placing devices M3 and M4 is a place control means which controls a component placing mechanism based on the solder test data to perform the component placing operation only on the unit substrates 4a in which the print data of the solder print data is good. In addition, the control units of the respective devices may have functions for controlling the data transmission/reception, respectively, without providing the management computer 3.

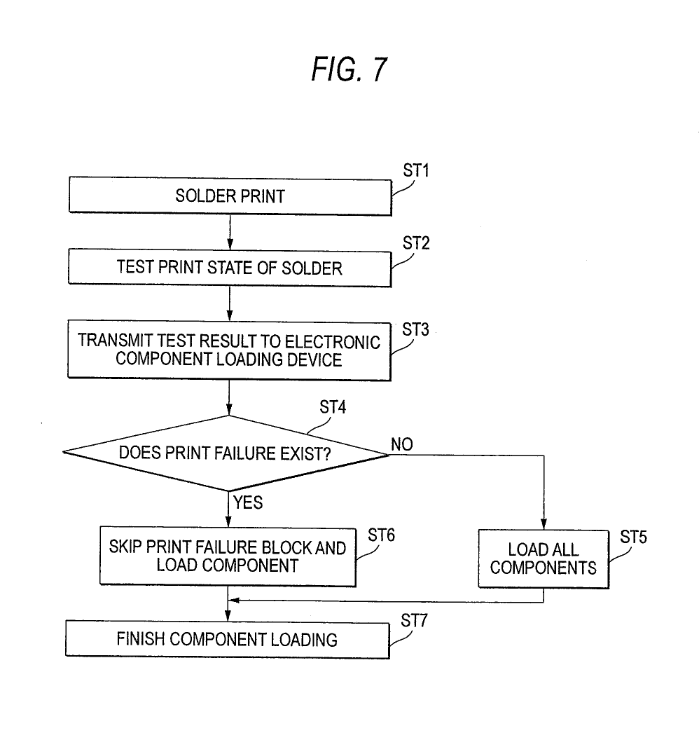

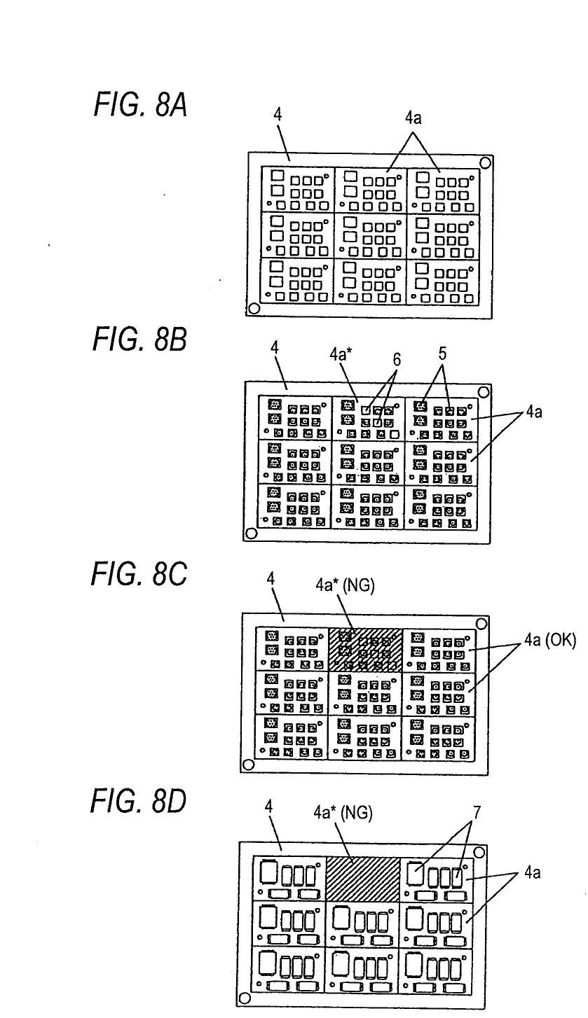

Next, the electronic component mounting process performed by the electronic component mounting system will be described with reference to FIGS. 7 and 8(a) to 8(d). FIG. 8(a) illustrates the substrate 4 which is the mounting object, that is, a multi-substrate in which the plurality of unit substrates 4a are assembled. In this electronic component mounting process, as illustrated in FIG. 8(b), the soldering paste 5 is printed on the substrate 4 by the print device M1 (ST 1). Here, the soldering paste 5 is printed on the all the electrodes 6 of the respective unit substrates 4a in the same print process. At this time, a print failure which the soldering paste 5 is not normally printed on the electrodes 6 may be generated by various causes. Here, an example that, in one unit substrate 4a*, the soldering paste 5 is not accurately printed on several electrodes 6 is illustrated.

Thereafter, the substrate 4 is transported to the print test device M2, in which the print state of the solder is tested with respect to the respective unit substrates 4a. At this time, the unit substrate 4a* including the electrode 6 having the bad print state is determined to be no good (NG), and the other unit substrates 4a are determined to be good (OK). In addition, the substrate 4 is transported to the electronic component placing device M3 and the solder test data representing the test result thereof is transmitted to the electronic component placing device M3 over the communication network 2 (ST3).

In the electronic component placing device M3, it is determined whether a print failure exists with reference to the transmitted solder test data when the respective unit substrates 4a are subjected to the component placing operation (ST4). Here, when the print failure does not exists, all the components, which are the mounting objects, are placed on all the unit substrates 4a (ST5) and the component placing is finished (ST7). On the contrary, as illustrated in FIG. 8(c), when the unit substrate 4a* which is determined to be no good (NG) exists, the print failure block of the substrate 4, that is, the corresponding unit substrate 4a* is skipped, and the electronic component 7 is placed on the unit substrates 4a which is determined to be good (OK), as illustrated in FIG. 8(d). Accordingly, the substrate 4 is discharged in the state that the electronic component is not placed on the unit substrate 4a* including the electrode 6 having the print failure.

In other words, the electronic component mounting method for mounting the electronic component on the multi-substrate by solderjoint to manufacture the mounting substrate includes a print test step for determining the quality of the print state of the soldering paste 5 printed on the electrodes 6 formed on the plurality of unit substrates 4a and outputting a determining result as the solder test data in every unit substrate 4a, and a component placing step for picking up the electronic component from a component supply unit by the component placing mechanism of the electronic component placing device M3 and placing the electronic component on the substrate 4 on which the soldering paste is printed.

In addition, in the component placing step, the component placing mechanism of the electronic component placing device M3 is controlled by the place control unit 37 based on the solder test data such that the component placing operation is performed only on the unit substrates 4a in which the print state of the soldering paste 5 is determined to be good. By using the test result of the print state as the feed-forward information to the electrode component placing device of the post-process, the following effect is obtained.

In other words, even in the conventional electronic component mounting system, the print state was tested after solder printing. However, in the conventional device, the test result was merely used for specifying the substrate which is determined to be bad by the print test. To this end, in the conventional device, the component is placed on even the unit substrate which is determined to be bad, similar to the other unit substrates, and the bad substrates are then collected after the solderjoint is performed in a reflow step. In addition, the mounted component is discarded by discarding the bad substrate. On the contrary, as described in the present embodiment, by using the test result of the print state as the feed-forward information, it is possible to prevent the waste due to the place of the component in the state that the print state of the solder is bad.

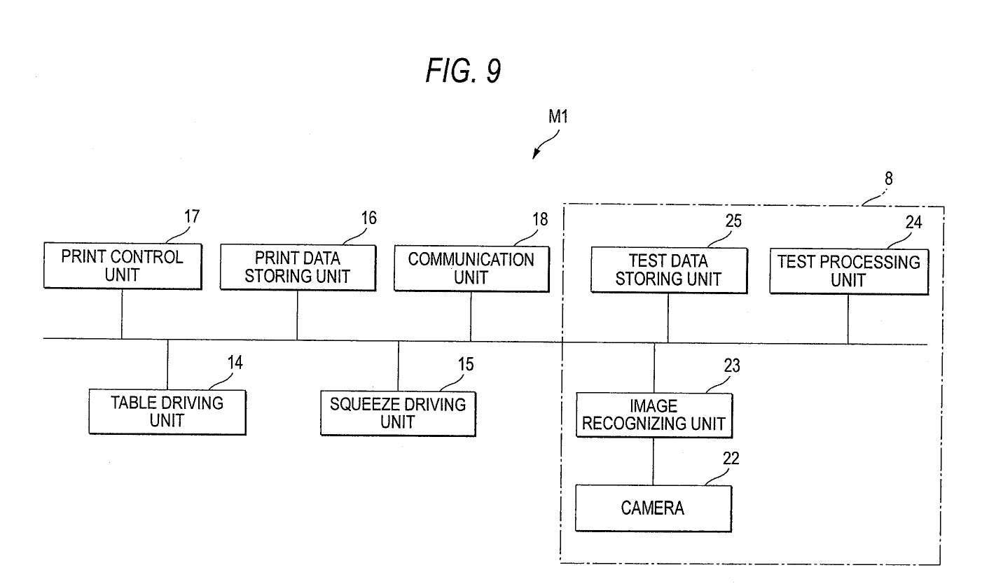

Furthermore, although, in the above-described embodiment, the print state of the solder is tested by a dedicated print test device, the print device M1 may have a function for testing the print state of the solder. In this case, as illustrated in FIG. 9, a test device 8 including the camera 22, the image recognizing unit 23, the test processing unit 24, and the test data storing unit 25 is provided in the print device M1. The function of the test device 8 is similar to that of the print test device M1 described with reference to FIG. 3. In addition, after the print operation of the print device M1 is finished, the corresponding print device M1 tests the print state of the solder.

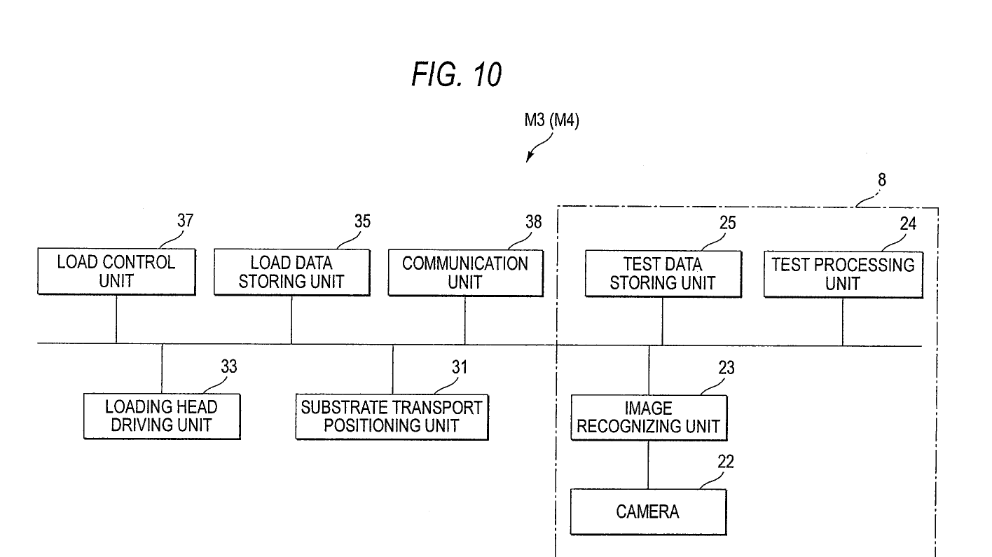

Furthermore, the electronic component placing device M3 may have the function for testing the print state of the solder. In this case, as illustrated in FIG. 10, the test device 8 is provided in the electronic component placing device M3. In addition, before the substrate 4 on which the solder is printed is carried into the electronic component placing device M3 and the component placing operation starts in the print device M1, the print state of the solder is tested by the test device 8.

In other words, the electronic component placing device having the above-described configuration places the electronic component on the substrate 4 which is the multi-substrate, and includes the test device 8 which has a print test function for determining the quality of the print state of the soldering paste 5 printed on the electrodes 6 formed on the plurality of unit substrates 4a and outputting the determination result as the solder test data in every unit substrate 4a, a component placing mechanism which picks up the electronic component from the component supply unit by the placing head 32 and places the electronic component on the plurality of unit substrates 4a on which the soldering paste 5 is printed, and the place control unit 37 as the place control means for controlling the component placing mechanism based on the solder test data and performing the component placing operation only on the unit substrates 4a in which the print state of the soldering paste 5 is determined to be good. The same effect as that of the electronic component mounting system illustrated in FIG. 1 is obtained by using the electronic component placing device having the above-described configuration.

This application is based upon and claims the benefit of priority of Japanese Patent Application No. 2005-9873 filed on Jan. 18, 2005, the contents of which are incorporated herein by reference in its entirety.

### INDUSTRIAL APPLICABILITY

According to an electronic component mounting system, an electronic component placing device, and an electronic component mounting method of the present invention, it is possible to prevent waste due to the place of the electronic component onto a unit substrate having a print failure. Accordingly, the present invention can apply to a technology of mounting an electronic component on a substrate by solderjoint to manufacture a mounting substrate.

1. An electronic component mounting system which includes a plurality of electronic component mounting devices connected to one another and mounts an electronic component on a multi-substrate in which a plurality of unit substrates are formed on the same substrate by solder joint to manufacture a mounting substrate, comprising:
a print device which prints a solder on electrodes of the plurality of unit substrates;
a print test device which determines the quality of a print state of the solder and outputs a determination result as solder test data in every unit substrate;
an electronic component placing device which has a component placing mechanism for picking up the electronic component from a component supply unit and placing the electronic component on the plurality of unit substrates on which the solder is printed; and
a place control means which controls the component placing mechanism based on the solder test data to perform a component placing operation only on the unit substrate in which the print state of the solder is determined to be good.

2. The electronic component mounting system according to claim 1, further comprising a communication unit which transmits the solder test data output from the unit substrates to the electronic component placing device.

3. An electronic component placing device for placing an electronic component in a multi-substrate on which a plurality of unit substrates are formed on the same substrate, comprising:
a print test unit which determines the quality of a print state of a solder printed on electrodes formed on the plurality of unit substrates and outputs a determination result as solder test data in every unit substrate;
a component placing mechanism which picks up the electronic component from a component supply unit and places the electronic component on the plurality of unit substrates on which the solder is printed; and
a place control means which controls the component placing mechanism based on the solder test data to perform a component placing operation only on the unit substrate in which the print state of the solder is determined to be good.

4. An electronic component mounting method for mounting an electronic component on a multi-substrate in which a plurality of unit substrates are formed on the same substrate, comprising:
a print test step for determining the quality of a print state of a solder printed on electrodes formed on the plurality of unit substrates and outputting a determination result as solder test data in every unit substrate; and
a component placing steps for picking up the electronic component from a component supply unit by a component placing mechanism and placing the electronic component on the plurality of unit substrates on which the solder is printed,
wherein, in the component placing step, the component placing mechanism is controlled based on the solder test data such that a component placing operation is performed only on the unit substrate in which the print state of the solder is determined to be good.

5. The electronic component mounting method according to claim 1, wherein the solder test data output from the unit substrates is transmitted to the component placing mechanism through a communication unit.
